(19) United States
(12) Patent Application Publication
(10) Pub. No.: US 2012/0246580 A1
(43) Pub. Date: Sep. 27, 2012

(54) SOCIAL POLLING

(75) Inventor: Randal Hampton Bouverat, El Segundo, CA (US)

(73) Assignee: Gether, LLC, El Segundo, CA (US)

(21) Appl. No.: 13/427,400

(22) Filed: Mar. 22, 2012

Related U.S. Application Data
(60) Provisional application No. 61/466,405, filed on Mar. 22, 2011.

(51) Int. Cl. G06F 3/01

(52) U.S. Cl. 715/753

(57) ABSTRACT

There is disclosed a system and method for social polling. The method comprises accepting input of a poll comprising a query and a plurality of responses to the query and obtaining a listing of contacts from a social network. The method further comprising accepting a selection of a subset of the contacts with whom to share the poll and sharing the poll by transmitting the poll to mobile devices associated with the subset. The method further comprising receiving responses to the poll, the responses input via the mobile devices and aggregating the responses into poll results including a profile of and poll response for each respondent in the subset.

### RELATED APPLICATION INFORMATION

This patent claims priority from U.S. provisional application No. 61/466,405 filed Mar. 22, 2011 and entitled “Social Polling.”

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to automated social polling.

2. Description of the Related Art

Polling is a common way for individuals or organizations to obtain marketing or directional data. For example, an individual may informally “poll” their friends about which outfit to wear or about which restaurant to attend. Similarly, organizations may send out polls via postal mail, electronic mail and similar methods in order to obtain opinions regarding their products, services or a proposed future plan. Online polling is the least expensive and best alternative for individuals and organizations because it is often coupled with automatic tabulation or aggregation of responses.

Social networks enable individuals and organizations to interact with more direct communications in a one-to-many form. For example, after an individual has indicated a willingness to “friend” a second individual or to “like” an organization, an affiliation is formed between that individual and the second individual or organization. The second individual or organization may then submit updates, provide offers and otherwise communicate with the individual and any others who have “friended” or “liked” the second individual or organization. Informal polls may be made in these update posts. In addition, some social networks provide the capability to generate “polls” of groups of “friends” or of those who “like” an organization's page. However, these social network polls do not enable mobile-to-mobile polling.

### DESCRIPTION OF THE DRAWINGS

FIG. 1 is a block diagram of an environment for social polling.

FIG. 2 is a block diagram of a computing device.

FIG. 3 is a functional block diagram of a system for social polling.

FIG. 4 is a flowchart for social polling.

Throughout this description, elements appearing in figures are assigned three-digit reference designators, where the most significant digit is the figure number where the element is introduced and the two least significant digits are specific to the element. An element that is not described in conjunction with a figure may be presumed to have the same characteristics and function as a previously-described element having the same reference designator.

### DETAILED DESCRIPTION

There is disclosed a system and method for social polling. The system and method includes the capability of a poll requestor to send polls to poll recipients via multiple mobile devices, including smart phones and tablet computers. The poll requestors may identify poll recipients from, among other places, their contacts on a social network. The poll requestors or poll participants may also participate in making predictions about the results of the poll. Excellent individual predictions or over time predictive aptitude may be rewarded. The polls may include attachments such as image, audio,video attachments. Links to web-based content or software code may also be included as attachments. These attachments may be attached to the poll or per answer to a poll. As responses to the poll are received, they are aggregated, stored and may be shared via mobile devices same and social networks.

Poll requestors may be organizations who utilize the polling functions through software-as-a-service (SaaS) or data-as-a-service (DaaS) portal. These portals enable the conducting of market research by configuring and customizing data and reporting analytics generated on the platform. The system further enables users and representatives to reach, view and subdivide the poll results based upon any parameters associated with the polls. The parameters may include, for example, demographics, location, categorical interest, keywords, links, images included, poll participants, poll requestor, poll subject and/or a customized group. Targeted offers or advertisements may be sent to the mobile devices associated with poll requestors or recipients based upon the polls they create or in which they participate.

Description of Apparatus

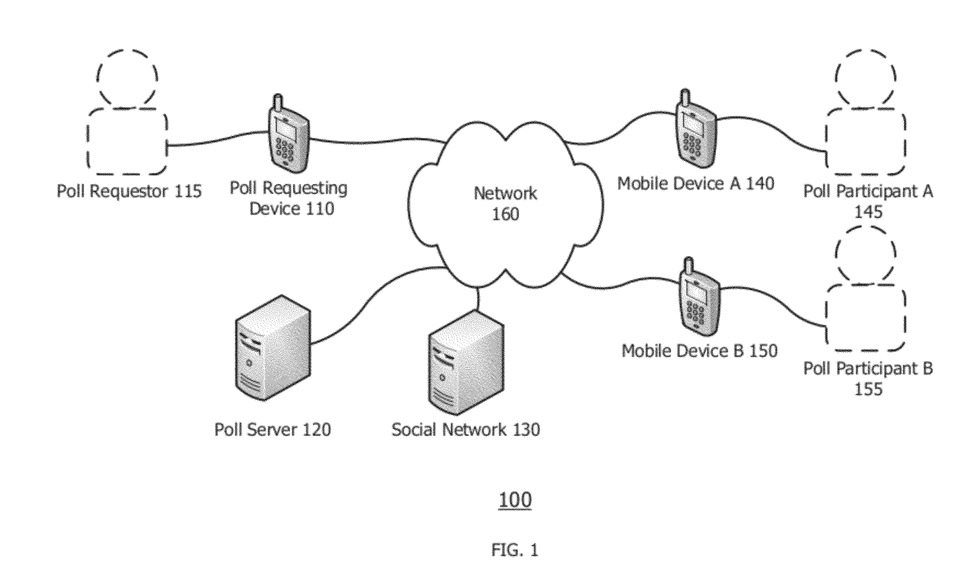

Referring now to FIG. 1, an environment 100 for social polling is shown. The environment 100 includes a poll server 120, a poll requesting device 110 used by poll requestor 115, a mobile device A 140 used by poll participant A 145, mobile device B 150 used by poll participant B 155, a social network 130 and a network 160. The network 160 interconnects each of the other elements of the environment 100.

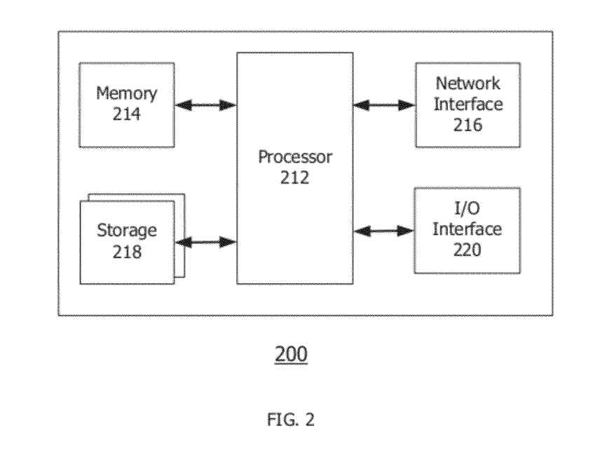

The poll requesting device 110 is shown as a mobile device, but may be any type of computing device (FIG. 2). A mobile application may operate on the poll requesting device 110 may be used to prepare and transmit polls. Alternatively, a web-based system, accessed via a web browser on the poll requesting device 110, may be used to prepare and transmit polls. The mobile application may access the web-based system in order to prepare and transmit polls. The poll requestor 115 transmits polls to poll participants.

The poll server 120 is a computing device running software for generating polls as directed by the poll requesting device 110 and transmits those polls via the network. Those polls may be generated in response to receipt of data from the poll requesting device 110 and may be forwarded, via the network 160, to the mobile device A 140 and mobile device B 150.

Social network 130 is one or more computers running software in order to operate a social network. The social network 130 is one to which the poll requestor 115, poll participant A 145 and poll participant B 155 belong. The social network 130 may be operated by a distinct entity from the other elements of the environment 100, but may provide application programming interface (API) for enabling the social network 130 and the information contained therein to be accessed by software. Alternatively, the social network 130 may operate on the same server or servers as the poll server 120.

Mobile device A 140 and mobile device B 150 are mobile devices, such as mobile telephones, tablet personal computers or handheld computers, running software suitable to receive polls created by the poll requesting device 110. This software may be a web-application accessed via a web-enabled application such as a web browser or mobile application incorporating web browser elements. In this way, poll participant A 145 and poll participant B 155 may receive and participate in the poll.

The network 160 may be or include the Internet. Software operating on the poll requesting device 110 may interact with the network 160 to generate polls that are then stored on the poll server 120. These polls may then be output to mobile devices A 140 and B 150 via a mobile telephone data network or wireless internet network making up a part of the network 160. The social network may be accessed, similarly, by any of the computing devices, using the network 160.

Turning now to FIG. 2 there is shown a block diagram of a computing device 200, which is representative of the poll server 120, the poll requesting device 110, the mobile device A 140, the mobile device B 150 and the social network 130. The computing device 200 may include software and/or hardware for providing functionality and features described herein. The computing device 200 may therefore include one or more of: logic arrays, memories, analog circuits, digital circuits, software, firmware and processors. The hardware and firmware components of the computing device 200 may include various specialized units, circuits, software and interfaces for providing the functionality and features described herein.

The computing device 200 has a processor 212 coupled to a memory 214, storage 218, a network interface 216 and an I/O interface 220. The processor 212 may be or include one or more microprocessors, field programmable gate arrays (FPGAs), application specific integrated circuits (ASICs), programmable logic devices (PLDs) and programmable logic arrays (PLAs).

The memory 214 may be or include RAM, ROM, DRAM, SRAM and MRAM, and may include firmware, such as static data or fixed instructions, BIOS, system functions, configuration data, and other routines used during the operation of the computing device 200 and processor 212. The memory 214 also provides a storage area for data and instructions associated with applications and data handled by the processor 212.

The storage 218 provides non-volatile, bulk or long term storage of data or instructions in the computing device 200. The storage 218 may take the form of a magnetic or solid state disk, tape, CD, DVD, or other reasonably high capacity addressable or serial storage medium. Multiple storage devices may be provided or available to the computing device 200. Some of these storage devices may be external to the computing device 200, such as network storage or cloud-based storage. As used herein, the term storage medium corresponds to the storage 218 and does not include transitory media such as signals or waveforms. In some cases, such as those involving solid state memory devices, the memory 214 and storage 218 may be a single device.

The network interface 216 includes an interface to a network such as network 160 (FIG. 1).

The I/O interface 220 interfaces the processor 212 to peripherals (not shown) such as displays, keyboards and USB devices.

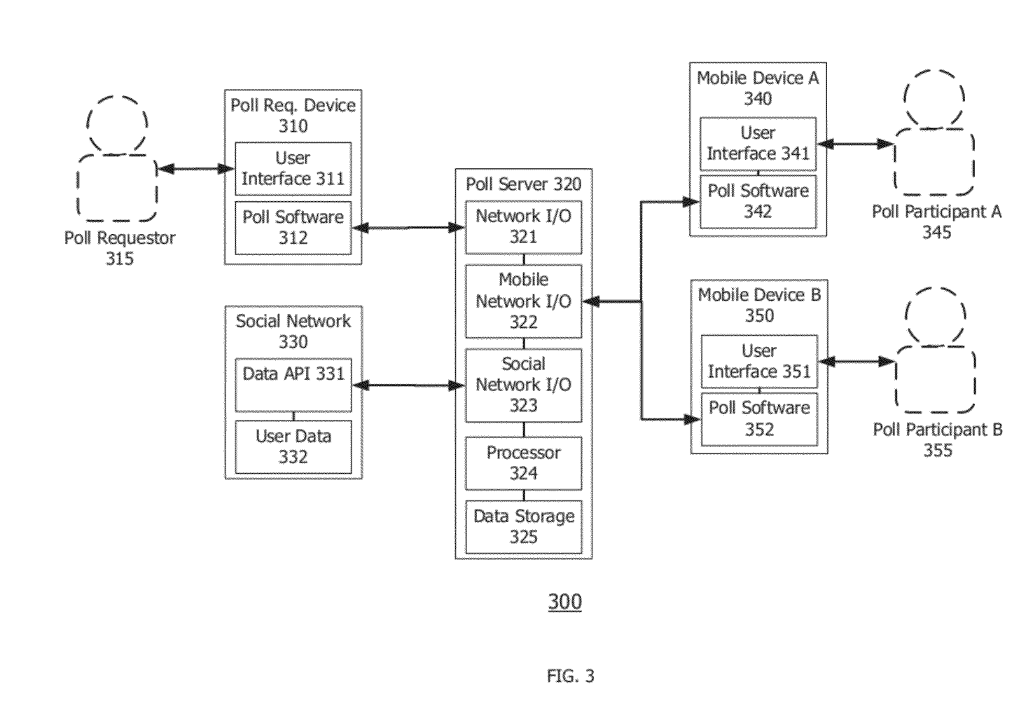

FIG. 3 shows a functional block diagram of a system 300 for social polling. FIG. 3 includes a poll server 320, poll requesting device 310, a social network 330, mobile device A 340 and mobile device B 350. These correspond to the poll requesting device 110, poll server 120, social network 130, mobile device A 140, mobile device B 150 of FIG. 1. FIG. 3 is as a series of software elements shown as logical blocks, each connected by the network 160 (FIG. 1). Each element of FIG. 3 operates on a computing device (FIG. 2) which may be a mobile computing device.

The poll requesting device 310 may be a mobile device or another computing device. The poll requesting device 310 includes software suitable for generating a poll as directed by a poll requestor 315. This software may be a web browser operating to access, via a network, a web page suitable for generating a poll as directed by a poll requestor 315. In particular, the user interface 311 may be used by the poll requestor 315 in conjunction with poll software 312 to generate a poll.

As used herein a “poll” is a query to a plurality of individuals, the poll transmitted to each of those individuals' mobile devices, combined with a plurality of answers to the query for selection by the individuals.

The poll requesting device 310 may be an individual's smart phone, tablet computer or other network-enabled mobile device. The individual may use the user interface 311 and poll software 312 installed on the poll requesting device 310 in order to generate a poll. The individual may input a query such as “Who is the greatest Beatle?” and a series of answers, such as “Paul McCartney,” “John Lennon,” “George Harrison” and “Ringo Starr.” Together, these elements make up the poll query. The poll may also include an image (for example one for each Beatle), audio, web link, video element or other, relevant attachment. The poll may also include a prediction request for the poll recipient to further participate in the poll by predicting the results of the poll or to predict the most popular answer to the poll. Similarly, the poll requestor may also provide a prediction. This prediction request may enable the poll recipient to further indicate his or her belief regarding the final results. The poll recipient may also comment on the poll. The poll software 312 may be web-based, accessible to the individual's smart phone. Alternatively, the poll requesting device 310 may be a personal computer and the poll software 312 may be desktop or web-based software.

The poll server 320 includes network input/output 321, mobile network input/output 322, social network input/output 323, a processor and data storage 325. The poll server 320 receives the poll queries via the network input/output 321. The poll server 320 may use the mobile network input/output 322 to communicate with the mobile device A 340 or mobile device B 350.

The poll server 320 may use the social network input/output 323 to communicate with the social network 330 via the data API 331 to obtain contacts from the social network 330. The processor 324 and associated data storage 325 may be used to process polls and to store the poll queries and results of those polls.

The social network 330 includes, at least, the data API 331 and user data 332. The data API 331 or application programming interface is used to interface with external software made by other software application developers. One of the ways in which social network providers augment the capabilities of the social network is to enable outside software application developers to access aspects of the social networking data via such data API 331. The social network 330 also stores user data 332 that includes individually-input data pertaining to each user and each of those user's connections. In situations in which the poll server 320 and social network 330 operate on the same server or set of servers, the user data 332 may be stored in the data storage 325. This user data 332 may include, among other data, contact information, such as email addresses and mobile telephone numbers, associated with each individual member of the social network 330. The user data 332 may also include indicia of user identification information for software installed on associated mobile devices.

The mobile device A 340 and mobile device B 350 are mobile devices used by poll participant A 345 and poll participant B 355, respectively. Each mobile device A 340 and B 350 includes a user interface 341 and 351 and poll software 342 and 352. These mobile devices A 340 and B 350 are used to receive poll queries and to submit answers. The poll software 342 and 352 may also be used to generate new polls, to contact new potential poll recipients, to track and review polls available to the user, generated by the user or in which the user has participated, to display a history of poll participation, to rank or otherwise grade polls questions, to sign up for participation in polls, or to resend polls to other mobile device users. The mobile device A 340 and mobile device B 350 may have access to the social network 330 separate from the poll server 320 and/or poll software 342 and 352, for example, in order to interact with the poll or poll results in order to share the results of the poll, to make predictions, to rank or otherwise categorize a poll query.

Description of Processes

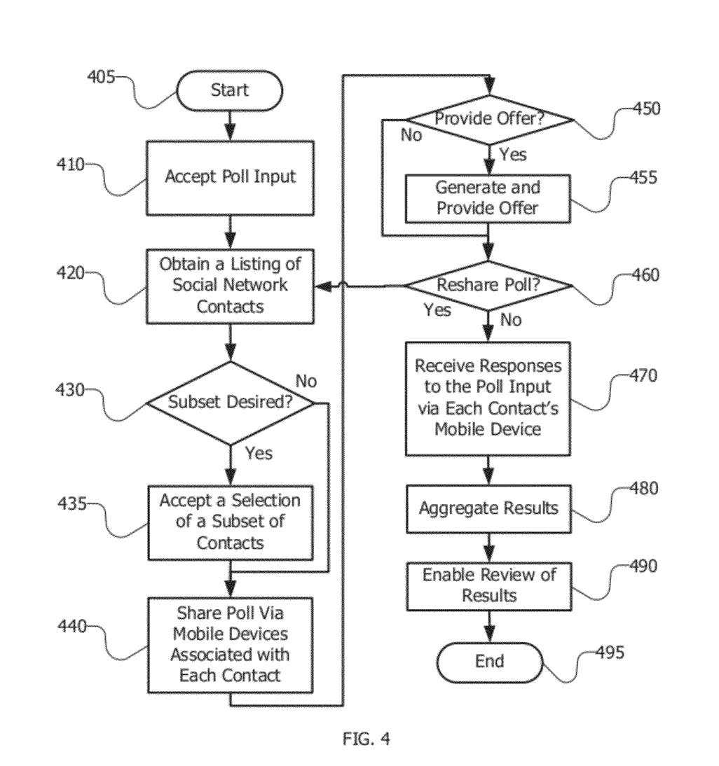

Referring now to FIG. 4, a flowchart for social polling is shown. First, a poll server, such as the poll servers 120 and 320, accepts a poll input by a requestor via a poll requesting device, such as the poll requesting devices 110 and 310, which includes polling software. The poll input may include one or more queries and two or more proposed answers to each query. The poll input may be, as described above, a poll query such as “Who is the greatest Beatle?” and the associated answers may be “Paul McCartney,” “John Lennon,” “George Harrison” and “Ringo Starr.” Upon receipt of a query and associated answers, the poll input is completed. The poll requestor may also input a one or more prediction for the poll. This prediction may, for example, indicate that the poll requestor expects that “John Lennon” will be the expected most popular result to the poll.

The poll input accepted at 410 may identify one or more social networks from which to obtain a listing of social network contacts. This listing may be stored on the poll requestor's mobile device or the poll server and may previously have been obtained from the social network. The poll server may then obtain the listing from the social network at 420. These contacts may be those affiliated with the poll requestor. In situations in which the poll requestor is an individual, the contacts may be all or a subset of the poll requestor's “friends” list or followers. In some cases, groupings of contacts may include individuals “following” other individuals in addition to “friends.” In situations in which the poll requestor is an organization, the contacts may be all or a subset of the poll requestor's “like” list, those who have self-identified as a member of an affiliate group or those who have elected to “follow” the organization. This process may use an API associated with accessing contact information related to the poll requestor's contacts in a social network such as the social network 330.

The API may enable the poll server to obtain sub-groups of contacts as well. For example, Facebook® has a “friends” list that is the entire group of friends a requestor has connected to his or her account. However, Facebook® users are able to create “lists” of individuals in the “friends” list and to give those lists names. Lists may be, for example, “college buddies” or “the girls.” The former being college buddies of the requestor, the latter being a close group of friends with whom the requestor affiliates. In some instances, the API may enable the poll server to obtain these contact sub-groups. If the capability is provided by the API, the requestor may direct the poll server to obtain one of these sub-groups by name. Alternatively, the API may enable the poll server, under the direction of a mobile device, to obtain all contacts and to maintain the “friends” lists or other groupings on the poll server or mobile device subject to subsequent rearrangement of the groupings and the creation of other, different sub-groups by the poll requestor.

When these contacts are obtained from a social network at 420, contact information associated with each of these contacts is also obtained. This contact information may include an email address, phone number, instant messaging account or other contact information. It may also include, if the requesting device and/or the associated polling software is registered with the social network, a unique user identification number or username associated with that user. That is, when a requestor registers the poll software with a social network, either upon download or by signing into the poll software using the social network, that individual may be given (or that individual's social network identification may be associated with) a unique identification for the polling software. In that way, the requestor may be contacted, via that unique identification. It is, effectively, another piece of contact information suitable for direct poll-software-to-poll-software communication.

Alternatively, the contacts obtained from the social network at 420 may be only those individuals who have self-identified as having poll software installed on their mobile devices. Still further alternatively, the contact list of the poll requestor may be cross referenced by the poll server system with a listing of individuals who have installed the poll software on their mobile devices. Any listing of contacts obtained from the social network or the poll server and may be automatically limited to those contacts who have already installed the poll software.

Those individuals who have installed the poll software may set up a profile. The profile may be fully or partially obtained from data input into an associated social network. As described above, the social network may be integrated with the poll software or may be a separate social network. The profile may include all relevant information the user is willing to include such as name, address, phone number, email address, age, location, job, educational history, photographs of the individual and similar data elements. The profile may also indicate that a user wishes to remain anonymous or to only share all or a subset of this profile information with poll requestors.

Once the social network contacts have been obtained, the requestor may indicate, via the polling software and the poll requesting device, that a subset of those contacts is desired 430. For example, the requestor may wish only to poll a small subset of friends using the poll software. This subset may be poll requestor-identified.

If a subset is desired, the poll server system may accept a selection of a subset of contacts 435. The poll software may present, via the user interface, the capability to select the subset from the obtained social network contacts. This selection may, for example, take the form of checkboxes next to the names of those social network contacts to whom the poll will be directed. This subset may be selected via poll requestor “swiping” or grouping. This subset may be identified by contact, by contact “list” or through various other lists. Similarly, “lists” or groups may be generated automatically or selected based upon other profile information such as location, employment, name, address, interest in or participation in certain groups and other similar profile information.

Once a subset of contacts obtained from the social network is accepted by the poll server or the poll requestor indicates no desire select a subset (thus indicating a desire to poll the entire contact list or a previously-identified list), the poll may be shared or “cast” via the mobile devices associated with each contact 440. This sharing may utilize the unique identification associated with a particular user. This unique identification may, for example, enable the poll server to “push” the poll to the poll software on each mobile device associated with the social networking contacts or the subset of social networking contacts.

Alternatively, a link to the poll may be sent, via text message, to a mobile telephone number or via email to an email address associated with a mobile device of the social networking contacts or subset of social networking contacts.

An offer may be provided in response to a poll 450. If an offer is desired, a relevant offer may be generated and provided 455. A poll may include content that indicates that a poll requestor is contemplating one or more purchases. The content may include keywords, images, web pages, links or other data contained in the poll.

For example, an individual shopping may create a poll identifying three or four options for shoe purchases. The poll query may be “Which shoe should I choose?” The keyword “shoe” may result in an offer of a discount on the purchase of shoes being provided to the poll requestor as the poll requestor sends the poll out to his or her friends. The user's location may also be taken into account in order to identify relevant, nearby retailers who may sell, for example, shoes. This offer may be presented to a poll requester after initiation of a poll. Alternatively, a similar offer may be presented to a poll recipient after a response to a poll has been provided.

Sharing of the poll by poll recipients may also be an option available to poll requestors. If available, the poll may be set, either by the poll requestor or by default, to enable poll resharing or “recasting.” The recipient may determine whether or not to reshare the poll 460. If resharing is desired, that user may use the poll software to direct the poll server to obtain a listing of social network contacts 420, determine whether a subset of those contacts is desired 430, accept a selection of the subset of contacts 440 and share the poll via mobile devices associated with those contacts 450.

If resharing is not enabled or the recipient does not desire to reshare the poll 460, then the poll server will receive the responses to the poll input by each contact using the contact's mobile device 470. That is, each poll response generated by the poll recipient using the poll software is received by the poll server.

Because the poll is provided from a mobile device to other mobile devices, the responses may be received very quickly after the poll is transmitted. The poll requestor and recipients may enable “push” notifications for the mobile software application on their respective mobile devices. If enabled, the users of these devices may receive immediate notification of a new poll and of new poll responses.

These results are aggregated 480 as they are received. Aggregation includes tabulation of results and generation of statistics for the results. This aggregation takes into account responses input by the original poll recipients, such as mobile device A 140 and mobile device B 150 and any recipients with whom the poll was reshared. The aggregation may differentiate between original recipients and those with whom the poll was reshared. Each recipient's profile may be appended, along with the recipient's response to the poll and to any prediction regarding the poll.

As a part of the results being aggregated 480, the accuracy of any predictions for the poll made by the poll requestor or any poll respondent may also be calculated. The accuracy of this prediction may be stored along with an on-going average and other statistics related to poll requestor and the poll respondent's predictive accuracy. Social network profiles for poll participants may include generated information pertaining to that respondent's predictive accuracy. The predictive accuracy may also be shared via a social network.

Rewards may be available, either offered by the poll requestor or by the social network, to poll participants with the highest predictive accuracy or based upon other predictions made for the poll. These rewards may include coupons, point-of-sale codes, transient or actual currency. These rewards may encourage participation in polls, careful selection of answers and increase the likelihood that a poll respondent will attempt accurate prediction.

These results may then be reviewed once the poll server enables review of the results 490. These results may be viewed via the poll software or web browser enabled software on the poll requesting device. Alternatively, access may be available via a stand-alone application or integration with an analytics application such that data may be accessed for analysis by a separate application.

The results and statistics may be updated in real-time by the poll server as additional poll recipients provide responses. An authorized requestor of the results, such as the poll requestor or a poll-requestor designated reviewer of the poll results, may view them. In some instances, an organization that has created the poll may wish to see the reactions of individual or groups of participants. The results may be sub-divided and categorized based upon the information available in each user's profile. This may include a breakdown by age range, location, address or other profile-based category.

In situations in which the poll has been reshared with contacts other than those originally selected by the poll requestor, those results may be displayed alongside those associated with the poll requestor or may be separately broken out. The results may be individualized in cases in which the respondent has elected to be identified individually. The results may be presented based upon the users demographic or other profile data, without references to a particular individual name or profile in cases in which the respondent has requested to remain anonymous.

During the process of review, the predictive accuracy may be yet another method by which the data may be reviewed either by the poll requestor, poll viewers or organizations related to the poll. For example, a poll requestor who enabled the respondents to input a prediction may be as interested in a particular user or group of users' capability to predict outcomes as the poll requestor is interested in the results of the poll. Rankings of the most accurate predictors may be generated based upon the respondents' predictive capability. These predictive results may be reviewed in a similar manner to the results of the poll.

The flow chart has both a start 405 and an end 495, but the process may be cyclical and iterative in nature.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A system for conducting social polling comprising:
a user interface for accepting input of a poll comprising a query and a plurality of responses to the query;
a social network interface for obtaining a listing of contacts associated with a poll requestor, the listing of contacts obtained from a social network;
the user interface further for selecting a subset of the listing of contacts with whom to share the poll;
a mobile network transceiver interface for sharing the poll by transmitting the poll to mobile devices associated with the subset and for receiving responses to the poll, the responses input via the mobile devices; and
a processor and associated data storage for aggregating the responses into poll results including a poll response for each respondent in the subset.

2. The system of claim 1 wherein the processor is further for responding to queries made to the poll results to thereby generate analytics of the poll results as directed by the queries.

3. The system of claim 1 wherein:
a second user interface further for enabling one of the subset to select a second subset from a second listing of contacts obtained from the social network;
a second mobile network transceiver interface for sharing the poll by transmitting the poll to a second set of mobile devices associated with the second subset and for receiving second responses to the poll, the responses input via the second set of mobile devices; and
wherein the processor and associated data storage are further for aggregating the second responses into the poll results, the poll results further including a second poll response for each respondent in the second subset.

4. The system of claim 1 wherein the user interface is further for providing an offer to one of a poll requestor and the mobile devices in response to the content of the poll.

5. The system of claim 1 wherein the processor and associated data storage are further for providing access to authorized requestors of the poll results.

6. The system of claim 1 wherein the user interface is further for creating a scheme for allocating rewards for each respondent, the rewards associated with submitting one of the responses to the poll.

7. Apparatus comprising a storage medium storing a program for social polling which when executed by a processor will cause the processor to:
accept input of a poll comprising a query and a plurality of responses to the query;
obtain a listing of contacts associated with a poll requestor, the listing of contacts obtained from a social network;
accept a selection of a subset of the contacts with whom to share the poll;
share the poll by transmitting the poll to mobile devices associated with the subset;
receive responses to the poll, the responses input via the mobile devices; and
aggregate the responses into poll results including a poll response for each respondent in the subset.

8. The apparatus of claim 7 wherein the instructions when executed by the processor further cause the processor respond to queries made to the poll results to thereby generate analytics of the poll results as directed by the queries.

9. The apparatus of claim 7 wherein the instructions when executed by the processor further cause the processor to:
enable one of the subset to select a second subset from a second listing of contacts obtained from the social network;
share the poll by transmitting the poll to a second set of mobile devices associated with the second subset and for receiving second responses to the poll, the responses input via the second set of mobile devices; and
aggregate the second responses into the poll results, the poll results further including a second poll response for each respondent in the second subset.

10. The apparatus of claim 7 wherein the instructions when executed by the processor further cause the processor to provide an offer to one of a poll requestor and the mobile devices in response to the content of the poll.

11. The apparatus of claim 7 wherein the instructions when executed by the processor further cause the processor to provide access to authorized requestors of the poll results.

12. The apparatus of claim 7 wherein the instructions when executed by the processor further cause the processor to create a scheme for allocating rewards for each respondent, the rewards associated with submitting one of the responses to the poll.

13. The apparatus of claim 7 further comprising:
a processor
a memory
wherein the processor and the memory comprise circuits and software for performing the instructions on the storage medium.

14. A method for conducting social polling comprising:
accepting input of a poll comprising a query and a plurality of responses to the query;
obtaining a listing of contacts associated with a poll requestor, the listing of contacts obtained from a social network;
accepting a selection of a subset of the contacts with whom to share the poll;
sharing the poll by transmitting the poll to mobile devices associated with the subset;
receiving responses to the poll, the responses input via the mobile devices; and
aggregating the responses into poll results including a poll response for each respondent in the subset.

15. The method of claim 14 further comprising responding to queries made to the poll results to thereby generate analytics of the poll results as directed by the queries.

16. The method of claim 1 further comprising:
enabling one of the subset to select a second subset from a second listing of contacts obtained from the social network;
sharing the poll by transmitting the poll to a second set of mobile devices associated with the second subset and for receiving second responses to the poll, the responses input via the second set of mobile devices; and
aggregating the second responses into the poll results, the poll results further including a second poll response for each respondent in the second subset.

17. The method of claim 14 further comprising providing an offer to one of a poll requestor and the mobile devices in response to the content of the poll.

18. The method of claim 14 further comprising providing access to authorized requestors of the poll results.

19. The method of claim 14 further comprising creating a scheme for allocating rewards for each respondent, the rewards associated with submitting one of the responses to the poll.
